(19) United States
(12) Patent Application Publication
(10) Pub. No.: US 2016/0142593 A1
(43) Pub. Date: May 19, 2016

(54) METHOD FOR TONE-MAPPING A VIDEO SEQUENCE

(71) Applicant: THOMSON LICENSING, Issy Les Moulineaux (FR)

(72) Inventors: Ronan BOITARD, Belz (FR); Dominique THOREAU, Cesson Sevigne (FR); Kadi BOUATOUCH, Rennes (FR); Remi COZOT, Remi (FR)

(21) Appl. No.: 14/893,106

(22) PCT Filed: May 20, 2014
(86) PCT No.: PCT/EP2014/060313

§ 371 Date: Nov. 23, 2015

(30) Foreign Application Priority Data
May 23, 2013 (EP) 13305668.9

(51) Int. Cl. H04N 5/14; G06T 5/00; H04N 5/57

(52) U.S. Cl. CPC H04N 5/145; H04N 5/57; G06T 5/007; G06T 2207/10016

(57) ABSTRACT

The present invention generally relates to a method and device for tone-mapping a video sequence in which a local tone-mapping operator is applied on each frame of the video sequence to be tone-mapped. The method is characterized in that the spatial neighborhoods used by said local-tone-mapping operator are determined on a temporal-filtered version of the frame to be tone-mapped.

### 1. FIELD OF INVENTION

The present invention generally relates to video tone-mapping. In particular, the technical field of the present invention is related to the local-tone mapping of video sequence.

### 2. TECHNICAL BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

High Dynamic Range (HDR) imagery is becoming widely known in both the computer graphics and image processing communities and benefits from using HDR technology can already be appreciated thanks to Tone

Mapping Operators (TMOs). Indeed, TMOs reproduce the wide range of values available in an HDR image on a LDR display (Low Dynamic Range). Note that a LDR frame has a dynamic range lower than the dynamic range of an HDR image.

There are two main types of TMOs: global and local operators.

Global operators use characteristics of an HDR frame, to compute a monotonously increasing tone map curve for the whole image. As a consequence, these operators ensure the spatial brightness coherency. However, they usually fail to reproduce finer details contained in the HDR frame.

On the contrary, local operators tone map each pixel based on its spatial neighborhood. These techniques increase local spatial contrast, thereby providing more detailed frames.

A well-known local TMO filters the spatial neighborhood of each pixel. The filtered image is used to scale each color channel to obtain the LDR frame (Chiu K., Herf M., Shirley P., Swamy S., Wang C., Zimmerman K.: Spatially Nonuniform Scaling Functions for High Contrast Images f. Interface, May (1993)).

More sophisticated solutions use a pyramidal approach, each level of the pyramid corresponding to a different size of the spatial neighborhood, each color channel is compressed using each level of the pyramid and blending all the results for all the levels provide the tone mapped frame. (Rahman Z., Jobson D.: A multiscale retinex for color rendition and dynamic range compression. SPIE International Symposium on (1996)).

Some other usual solutions use frequency subband decomposition to preserve finer details. The subbands are processed separately then combined to obtain the tone mapped frame (Tumblin J.: LCIS: A boundary hierarchy for detail-preserving contrast reduction. Proceedings of the 26th annual conference on (1999)).

The Photographic Tone Reproduction (PTR) [RSSF02] operator relies on a Laplacian pyramid decomposition (Reinhard E., Stark M., Shirley P., Ferwerda J.: Photographic tone reproduction for digital images. ACM Trans. Graph. 21, 3 (July 2002), 267{276.). A threshold allows to select the best neighborhood's size to use for each pixel rather than blending.

Other well-known solutions is to use the Gradient Domain Compression (GDC) in order to perform the tone mapping in the gradient domain (Fattal R., Lischinski D.: Gradient domain high dynamic range compression. ACM Transactions on Graphics (2002)). The gradient is computed from a spatial neighborhood around a pixel at each level of a gaussian pyramid. A scaling factor is determined for each pixel based on the magnitude of the gradient. All the gradient fields are combined at full resolution to obtain the compressed gradient field. As this gradient field is not always integrable, a close approximation is used to compute the tone-mapped frame.

Applying a TMO separately to each frame of an input video sequence usually results in temporal incoherency. There are two main types of temporal incoherency: flickering artifacts and temporal brightness incoherency.

Flickering artifacts are either due to the TMO or to the scene. Indeed, flickering artifacts due to the TMO are caused by rapid changes of the tone map curve in successive frames. As a consequence, similar HDR luminance values are mapped to different LDR values. Flickering due to the scene corresponds to rapid changes of the illumination condition. Applying a TMO without taking into account temporally close frames results in different HDR values mapped to similar LDR values. As for temporal brightness incoherency, it occurs when the relative HDR frame's brightnesses are not preserved during the course of the tone mapping process. Consequently, frames perceived as the brightest in the HDR sequence are not necessarily the brightest in the LDR sequence. Unlike flickering artifacts, brightness incoherency does not necessarily appears along successive frames.

In summary, applying a TMO, global or local, to each frame separately of an HDR video sequence, results in temporal incoherency.

Solutions, based on temporal filtering of the tone map curve have been designed (Boitard R., Thoreau D., Bouatouch K., Cozot R.: Temporal Coherency in Video Tone Mapping, a Survey. In HDRi2013—First International Conference and SME Workshop on HDR imaging (2013), no. 1, pp. 1-6). However, these techniques only work for global TMOs, as local TMOs have a non-linear and spatially varying tone map curve. For local TMOs, preserving temporal coherency consists in preventing high variations of the tone mapping over time and space. A solution, based on the GDC operator, has been proposed by Lee et al. (Lee C., Kim C.-S.: Gradient Domain Tone Mapping of High Dynamic Range Videos. In 2007 IEEE International Conference on Image Processing (2007), no. 2, IEEE, pp. III-461-III-464.).

First, this technique performs a pixel-wise motion estimation for each pair of successive HDR frames and the resulting motion field is then used as a constraint of temporal coherency for the corresponding LDR frames. This constraint ensures that two pixels, associated through a motion vector, are tone mapped similarly.

Despite the visual improvement brought by this technique, several shortcomings still exist. First, this solution preserves only temporal coherency between pairs of successive frames. Second, it depends on the robustness of the motion estimation. When this estimation fails, the temporal coherency constraint is applied to pixels belonging to different objects. This motion estimation problem will be referred to as non-coherent motion vector. Moreover, this technique is designed for only one local TMO, the GDC operator, and cannot extend to other TMOs.

### 3. SUMMARY OF THE INVENTION

To solve at least one of the above-cited drawbacks of the state-of-the-art and in particular to stabilize the computation of the spatial neighborhoods of the local TMO throughout time, the spatial neighborhoods of the local TMO which is used to tone map a video sequence, are determined on a temporal-filtered version of the frame to be tone-mapped.

Using a temporal-filtered version of the frame to be tone-mapped rather than (as usual) the original luminance of the frame to determine the spatial neighborhoods of the tone-mapped operator allows to preserve temporal coherency of the spatial neighborhoods and thus to limit flickering artifacts in the tone-mapped frame.

According to an embodiment, the method comprises
obtaining a motion vector for each pixel of the frame to be tone-mapped, and
motion compensating some frames of the video sequence using the estimated motion vectors and temporally filtering the motion-compensated frames to obtain the temporal-filtered version of the frame to be tone-mapped.

According to an embodiment, the method further comprises
detecting non-coherent motion vectors and temporally filtering each pixel of the frame to be tone-mapped using an estimated motion vector only if this motion vector is coherent.

According to an embodiment, a motion vector is detected as being non-coherent when an error between the frame to be tone-mapped and a motion-compensated frame corresponding to this motion vector is greater than a threshold.

According to another of its aspects, the invention relates to a device for tone-mapping a video sequence comprising a local tone-mapping operator. The device is characterized in that it further comprises means for obtaining a temporal-filtered version of a frame of the video sequence to be tone-mapped and means for determining the spatial neighborhoods used by said local-tone-mapping operator.

The specific nature of the invention as well as other objects, advantages, features and uses of the invention will become evident from the following description of a preferred embodiment taken in conjunction with the accompanying drawings.

### 4. LIST OF FIGURES

The embodiments will be described with reference to the following figures:

FIG. 1a shows a diagram of the steps of the method for tone-mapping a video sequence.

FIG. 1b shows a diagram of the steps of a method to compute a temporal-filtered version of a frame to be tone-mapped of the video sequence.

FIG. 1c shows a diagram of the steps of a variant of the method to compute a temporal-filtered version of a frame to be tone-mapped of the video sequence.

FIG. 2 illustrates an embodiment of the step 100 and 200 of the method.

FIGS. 3 and 4 illustrate another embodiment of the steps 100 and 200 of the method.

FIG. 5 shows an example of an architecture of a device comprising means configured to implement the method for tone-mapping a video sequence.

### 5. DETAILED DESCRIPTION OF A PREFERRED EMBODIMENT OF THE INVENTION

A frame (also called an image) comprises pixels or frame points with each of which is associated at least one item of frame data. An item of frame data is for example an item of luminance data or an item of chrominance data.

Generally speaking, the method for tone-mapping a video sequence consists in applying a local-tone-mapping frame by frame to each frame of the video sequence.

The method is characterized in that the spatial neighborhoods used by said local-tone-mapping operator are determined on a temporal-filtered version of the frame to be tone-mapped.

The definition of the spatial neighborhoods of the local TMO follows thus a temporal coherency i.e. they have a more stable definition from frame to frame preventing flickering artifacts on the tone-mapped version of the frames to be tone-mapped.

One of the advantage of the method is that any state of the art local-tone-mapping operator may be used because the temporal-filtered version of the frame to be tone-mapped is only used to determine their spatial neighborhoods.

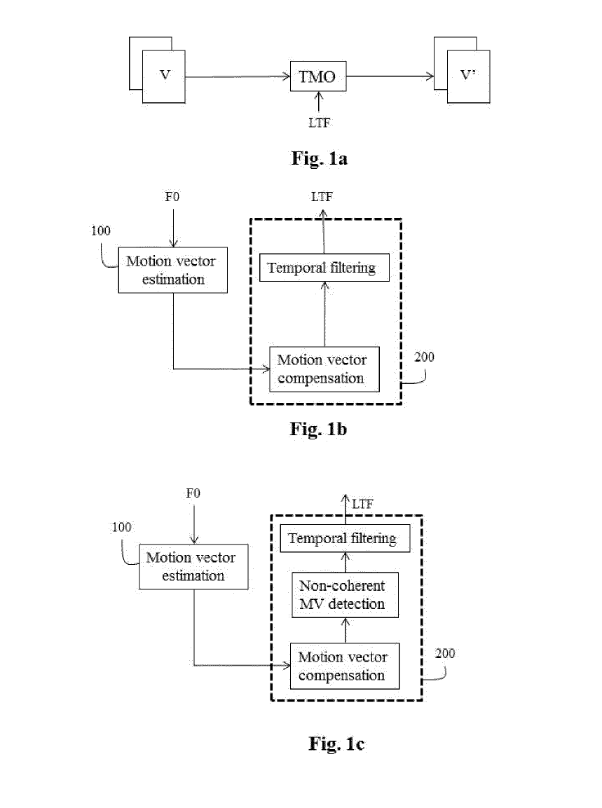

FIG. 1a shows a diagram of the steps of the method for tone-mapping a video sequence in which a temporal-filtered version is obtained for each frame to be tone-mapped F0.

The input video sequence may be, for example a High Dynamic Range video sequence (HDR) and the tone-mapped video sequence V′ may be a Low Dynamic Range (LDR) i.e a video sequence having a lower dynamic range than the input video sequence V. TMO refers to any state-of-the-art local-tone-mapping operator. The temporal-filtered version of the frame to be tone-mapped is called the temporal-filtered frame L_{TF} in the following.

According to an embodiment of the method, the temporal-filtered frame L_{TF} is obtained from a memory or a remote equipment via a communication network.

FIG. 1b shows a diagram of the steps of a method to compute a temporal-filtered frame L_{TF} from a frame to be tone-mapped F0 of the video sequence.

At step 100, obtaining a motion vector for each pixel of the frame F0.

According to an embodiment, the motion vector for each pixel of the frame F0 is obtained from a memory or a remote equipment via a communication network.

According to an embodiment of the motion estimation step 100, a motion vector (δₓ,δ_{y}) is defined in order to minimize an error metric between the current block and an estimated matching block.

For example, the most common metrics used in motion estimation is the Sum of Absolute Difference (SAD) given by:

$$SAD = {\sum }_{( x , y ) εΩ} \vert A ( x , y ) - B ( x + {δ}_{x} , y + {δ}_{y} ) \vert$$

where Ω represents all the pixel positions (x,y) of the square-shape block used.

At step 200, motion compensating some frames of the video sequence V using the estimated motion vectors and temporally filtering the motion-compensated frames to obtain the temporal-filtered fame L_{TF}.

The steps 100 and 200 together correspond to an usual Motion Compensated Temporal Filtering (MCTF) technique.

According to a variant of the step 200 illustrated in FIG. 1c, non-coherent motion vectors are detected and each pixel of the frame to be tone-mapped is then temporally filtered using an estimated motion vector only if this motion vector is coherent.

This solves the non-coherent motion vector problem because it avoids the motion-compensation of pixels which belong to different objects of the frame F0 which causes some ghosting artifacts in the tone-mapped version of the frame F0.

According to an embodiment of the steps 100 and 200, a length N of a temporal filter is obtained, (N−1) motion-compensated frames are obtained through motion-compensation of the current frame in regard to the frame F0 thanks to the estimated motion vectors and the temporal-filtered frame L_{TF} then results from the temporal filtering of said motion-compensated frames using said temporal filter.

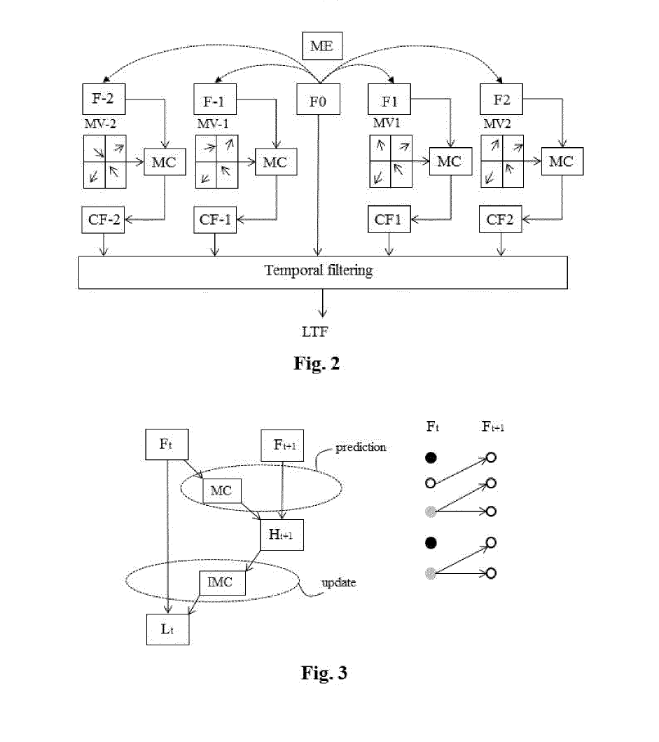

As illustrated in FIG. 2, the length N of the temporal filter equals 5 (N=5) and (N−1) motion vectors MVn are estimated (ME): one for each of the two previous frames F−2 and F−1 and one for each of the two following frames F1 and F2. The temporal-filtered frame L_{TF} is then obtained as the output of a temporal filter of length N having as input the (N−1) motion-compensated frames CF−n obtained by motion-compensation of the current frame in regard to the frame F0 thanks to the estimated motion vectors MVn. Such inputs are a motion-compensated frame CF−2 which is obtained thanks to the motion vector MV−2, a motion-compensated frame CF−1 which is obtained thanks to the motion vector MV−1, a motion-compensated frame CF1 which is obtained thanks to the motion vector MV1 and a motion-compensated frame CF2 which is obtained thanks to the motion vector MV2.

Four motion-compensated frames are thus obtained according to this example.

Many types of temporal filtering can be used, the simple one being an averaging given by:

$${L}_{TF} ( x , y ) = \frac{( {F}_{0} + {\sum }_{n = \frac{N}{2} , n \neq 0}^{N / 2} {CF}_{n} ( x , y ) )}{N} \qquad ( 1 )$$

where CFn represents the n^{th} motion-compensated frame.

The invention is not limited to any type of temporal filtering and any other temporal filtering usually used in signal processing may also be used. A specific value of the length of the temporal filter is not a restriction to the scope of the invention.

According to an embodiment of the variant illustrated in FIG. 1c of the embodiment of the steps 100 and 200 described in relation with the FIG. 2, a motion vector is detected as being non-coherent when an error εₙ(x,y) between the frame F0 and a motion-compensated frame CFn corresponding to this motion vector is greater than a threshold.

According to an embodiment, the error εₙ(x,y) is given by:

$${ɛ}_{n} ( x , y ) = \frac{\vert {F}_{0} ( x , y ) - {CF}_{n} ( x , y ) \vert}{{F}_{0} ( x , y )}$$

According to an embodiment, the threshold is proportional to the value of the pixel of the current frame F0.

For example, a motion vector is detected as being non-coherent when:

εₙ(x,y)>T

where T is a user-defined threshold, (x,y) the pixel position.

Each pixel in a motion-compensated frame CFn that corresponds to a coherent pixel is used in the temporal filtering in order to obtain the frame L_{TF}. If at a given position there is no coherent motion vector then only the pixel value of the frame F0 is used (no temporal filtering).

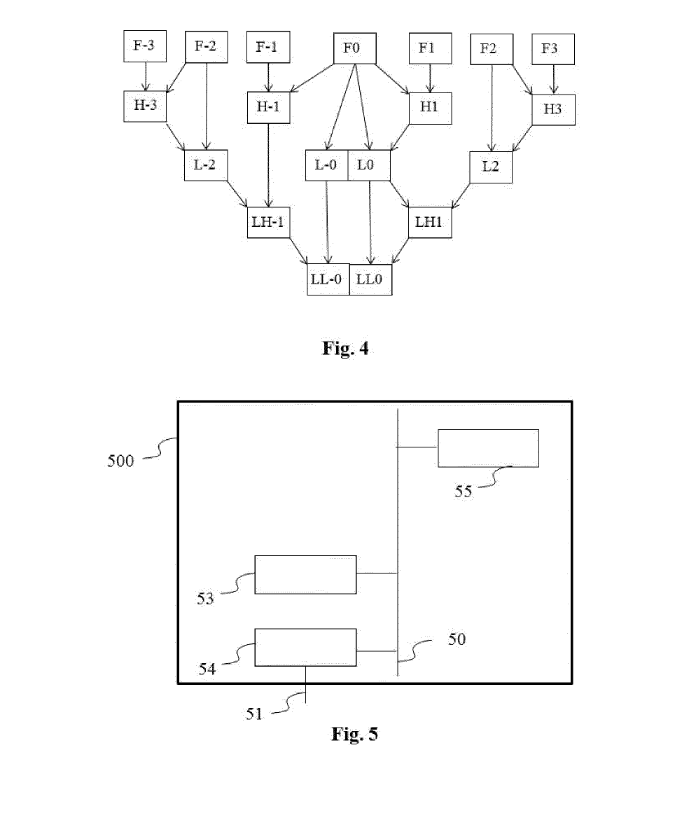

According to another embodiment of the steps 100 and 200 illustrated in FIGS. 3 and 4, a backward- and a forward-oriented motion compensation combined with a dyadic wavelet decomposition is applied on the frame F0 in order to obtain several low frequency subbands. For each pixel of the frame F0, at least one low frequency subband of the backward part of the decomposition is selected and at least one low frequency subband of the forward part of the decomposition is selected and the pixel of the frame L_{TF} of is a blending of the two pixels belonging to the two selected low frequency subbands.

An usual dyadic wavelet decomposition builds a pyramid where each level corresponds to a temporal frequency. Each level is computed using a prediction and an update step as illustrated in FIG. 3. To perform a motion compensated decomposition, the motion vector resulting from a motion estimation is used in the prediction step. A frame Hₜ₊₁ is obtained from the difference between a frame Fₜ₊₁ and a motion-compensated version of a frame Fₜ (MC). In the course of the update step, a low frequency frame Lₜ is obtained by adding the frame Fₜ with the inverted-motion-compensated version of the frame Hₜ₊₁. That may result in unconnected pixels (dark point in FIG. 3) or multi-connected pixels (grey points in FIG. 3) in the low frequency subband Lₜ. Unconnected or multiple-connected pixels are pixels that have no associated pixels respectively multi-connected pixels when the motion vectors are reverted.

To avoid this drawback, a specific structure for the decomposition into multiple levels is applied on the frame F0 as illustrated in FIG. 4 in the case of a 2-level decomposition.

Such a decomposition of the frame F0 uses an orthonormal transform which uses a backward and a forward motion vector:

$${H}_{t + 1} ( n ) = \frac{{F}_{t + 1} ( n ) - {F}_{t} ( n - {v}_{b} )}{2}$$

$${L}_{t} ( p ) = {F}_{t} ( p ) - {H}_{t} ( p - {v}_{f} )$$

where Hₜ and Lₜ are respectively the high and low frequency subbands, v_{b} and v_{f} are respectively the backward and forward motion vector while n is the pixel position in frame Fₜ₊₁ and p corresponds to n+v_{b}.

Such specific structure of the decomposition ensures that the temporal filtering is centered on the frame F0.

Applying such an orthonormal transform provides two low frequency subbands in the case of the 2-level decomposition shown in FIG. 4.

According to a variant of the embodiment, the length of the temporal filter is adaptively selected for each pixel of the frame F0.

This is advantageous because it provides a more robust motion estimation and thus more stable definition of the neighborhood of the TMO.

According to an embodiment of the variant illustrated in FIG. 1b of the embodiment of the steps 100 and 200 described in relation with the FIG. 4, a backward motion vector v_{b}, respectively a forward motion vector v_{f}, is detected as being non-coherent when an error ε_{b,n}(x,y), respectively ε_{f,n}(x,y), between the frame F0 and a low frequency subband of the backward part of the decomposition, respectively of the forward part of the decomposition, is greater than a threshold.

According to an embodiment, the errors are given by:

$${ɛ}_{b , n} ( x , y ) = \frac{\vert {F}_{0} ( x , y ) - {L}_{b , n} ( x , y ) \vert}{{F}_{0} ( x , y )}$$

$${ɛ}_{f , n} ( x , y ) = \frac{\vert {F}_{0} ( x , y ) - {L}_{f , n} ( x , y ) \vert}{{F}_{0} ( x , y )}$$

where L_{b,n}(x,y) and L_{f,n}(x,y) is a low frequency subband of the backward-respectively forward part of the decomposition (L−0, L0, LL−0, LL0 in FIG. 4).

According to an embodiment, the threshold is proportional to the value of the pixel of the current frame F0.

For example, a backward motion vector is detected as being non-coherent when:

ε_{b,n}(x,y)>T

where T is a user-defined threshold, (x,y) the pixel position. The same example may be used for the forward motion vector.

According to an embodiment, starting from the lowest frequency subband of the backward and the forward parts of the decomposition, all the low frequency subbands of the decomposition are considered and a single low frequency subband is selected for each pixel of the frame to be tone-mapped when the corresponding motion vector is coherent.

A pixel in the temporal-filtered frame L_{TF} may then be relative to two low frequency subbands. In that case the pixel is a blending of the two pixels belonging to the two selected low frequency subbands (dual-oriented filtering). Many types of blending can be used such as an averaging or weighted averaging of the two selected low frequency subbands.

If only one of the two low frequency subband can be selected, the pixel value in the temporal-filtered frame L_{TF} equals to the value of the pixel value of the selected low frequency subband (single-oriented filtering).

None of the two low frequency subband can be selected, the pixel value in the temporal-filtered frame L_{TF} equals to the value of the frame F0 (no temporal filtering).

On FIG. 1a, 1b, 2-4, the modules are functional units, which may or not be in relation with distinguishable physical units. For example, these modules or some of them may be brought together in a unique component or circuit, or contribute to functionalities of a software. A contrario, some modules may potentially be composed of separate physical entities. The apparatus which are compatible with the invention are implemented using either pure hardware, for example using dedicated hardware such ASIC or FPGA or VLSI, respectively <<Application Specific Integrated Circuit>>, <<Field-Programmable Gate Array>>, <<Very Large Scale Integration>>, or from several integrated electronic components embedded in a device or from a brend of hardware and software components.

FIG. 5 shows a device 500 that can be used in a system that implements the method of the invention. The device comprises the following components, interconnected by a digital data- and address bus 50:
a processing unit 53 (or CPU for Central Processing Unit);
a memory 55;
a network interface 54, for interconnection of device 500 to other devices connected in a network via connection 51.

Processing unit 53 can be implemented as a microprocessor, a custom chip, a dedicated (micro-) controller, and so on. Memory 55 can be implemented in any form of volatile and/or non-volatile memory, such as a RAM (Random Access Memory), hard disk drive, non-volatile random-access memory, EPROM (Erasable Programmable ROM), and so on. Device 500 is suited for implementing a data processing device according to the method of the invention. The processing unit 53 and the memory 55 work together for obtaining a temporal-filtered version of a frame to be tone-mapped. The memory 55 may also be configured to store the temporal-filtered version of the frame to be tone-mapped. Such a temporal-filtered version of the frame to be tone-mapped may also be obtained from the network interface 54. The processing unit 53 and the memory 55 work also together for determining the spatial neighborhoods of a local-tone-mapping operator on a temporal-filtered version of a frame of the video sequence to be tone-mapped and potentially for applying such an operator on the frame to be tone-mapped.

The processing unit and the memory of the device 500 are also configured to implement any embodiment and/or variant of the method described in relation to FIG. 1a, 1b, 2-4.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments necessarily mutually exclusive of other embodiments.

Reference numerals appearing in the claims are by way of illustration only and shall have no limiting effect on the scope of the claims.

While not explicitly described, the present embodiments and variants may be employed in any combination or sub-combination.

1-9. (canceled)

10. Method for tone-mapping a video sequence in which a local tone-mapping operator is applied on each pixel of each frame of the video sequence to be tone-mapped, characterized in that the spatial neighborhoods defined around the pixels to be tone-mapped and used by said local-tone-mapping operator are determined on a temporal-filtered version of the frame to be tone-mapped.

11. Method according to claim 10, wherein the method comprises
obtaining a motion vector for each pixel of the frame to be tone-mapped, and
motion compensating some frames of the video sequence using the estimated motion vectors and temporally filtering the motion-compensated frames to obtain the temporal-filtered version of the frame to be tone-mapped.

12. Method according to the claim 11, wherein the method further comprises
detecting non-coherent motion vectors and temporally filtering each pixel of the frame to be tone-mapped using an estimated motion vector only if this motion vector is coherent, a motion vector being detected as being non-coherent when an error (εₙ(x,y), ε_{b,n}(x,y), ε_{f,n}(x,y)) between the frame to be tone-mapped and a motion-compensated frame corresponding to this motion vector is greater than a threshold.

13. Method according to claim 12, wherein a length N of a temporal filter is obtained, motion-compensated frames are obtained through motion-compensation of the current frame in regard to the frame to be tone-mapped thanks to the estimated motion vectors and the temporal-filtered version of the frame to be tone-mapped) then results from the temporal filtering of said motion-compensated frames using said temporal filter.

14. Method according to claim 12, wherein a dyadic wavelet decomposition is applied on the frame to be tone-mapped to build a pyramid where each level corresponds to a low frequency frame belonging to either a forward or backward part, each low frequency subband of each part being computed by using:
a motion prediction step in the course of which a frame Hₜ₊₁ is obtained from the difference between a reference frame Fₜ₊₁ and a backward or forward motion-compensated version of a current frame Ft; and
an update step in the course of which a low frequency frame Lₜ belonging to either a forward or backward part is obtained by adding the frame Fₜ with the inverted-motion-compensated version of the frame Hₜ₊₁,
for each pixel of the frame to be tone-mapped, at least one low frequency frame of the backward part is selected and at least one low frequency frame of the forward part are selected and the pixel of the temporal-filtered version of the frame to be tone-mapped is a blending of the two pixels belonging to the two selected low frequency frames.

15. Method according to the claim 15, wherein starting from the lowest frequency subband of the backward and the forward parts of the decomposition, all the low frequency subbands of the decomposition are considered and a single low frequency subband is selected for each pixel of the frame to be tone-mapped when the corresponding motion vector is coherent.

16. Device for tone-mapping a video sequence comprising a local tone-mapping operator, wherein it further comprises means for obtaining a temporal-filtered version of a frame of the video sequence to be tone-mapped and means for determining the spatial neighborhoods defined around the pixels to be tone-mapped and used by said local-tone-mapping operator.

17. Device according to the claim 16, wherein it further comprises means configured to implement one of the method according to claim 10.
